(19) United States
(12) Patent Application Publication
(10) Pub. No.: US 2022/0110021 A1
(43) Pub. Date: Apr. 7, 2022

(54) FLOW FORECASTING FOR MOBILE USERS IN CELLULAR NETWORKS

(71) Applicant: Continual Ltd., Caesarea (IL)

(72) Inventors: Eshai LIVNE, Karkur (IL); Jose Mauricio COHENCA, Netanya (IL); Yizhar RONEN, Hod-HaSharon (IL); Yosef BAR YOSEF, Hod-HaSharon (IL); Hadas BEN-AMI, Kadima Tzoran (IL); Rita BACK, Kfar-Saba (IL); Shmuel MORAD, Hod-HaSharon (IL)

(73) Assignee: Continual Ltd., Caesarea (IL)

(21) Appl. No.: 17/062,652

(22) Filed: Oct. 5, 2020

(51) Int. Cl. H04W 28/08; H04W 28/02; H04L 12/801

(52) U.S. Cl. CPC H04W 28/0942; H04W 28/0289; H04L 47/127; H04W 28/0231; H04W 28/0838; H04W 28/021

(57) ABSTRACT

Disclosed herein are methods, systems and computer program products for predicting a cellular traffic load in a certain geographical area deployed with a plurality of network infrastructure apparatuses by identifying in-motion vehicular cellular devices moving in the certain geographical area and using one or more trained Machine Learning (ML) Models to predict the future cellular traffic load for one or more of the plurality of network infrastructure apparatuses based on an estimated future location of the vehicular cellular devices and a predicted cellular data consumption of the vehicular cellular devices. The future cellular traffic load may be provided to one or more cellular traffic management systems which may take one or more actions in advance based on the predicted future cellular traffic load.

### FIELD AND BACKGROUND OF THE INVENTION

The present invention, in some embodiments thereof, relates to optimizing utilization and service of cellular network traffic, and, more specifically, but not exclusively, to optimizing utilization and service of cellular network traffic based on future cellular network traffic load estimated by predicting future locations of in-motion vehicular cellular devices and further predicting their cellular data consumption.

Deployment of cellular devices is rapidly an immensely growing in high numbers both due to increase in personal devices used by users but more so by deployment of connected devices such as Internet of Thinks (IoT). In addition, the data consumption of these cellular devices and the cellular services is constantly increasing.

The major need for cellular network connectivity and service is therefore rapidly increasing requiring expanding cellular network infrastructure and improving cellular network management and utilization to handle the huge volumes of cellular data exchanged over the cellular network.

This challenge is further increased with the major advancements in transportation since mobile cellular devices widely deployed require high serviceability. This may be attributed to the mass transportation means (buses, trams, trains, underground trains, etc.) transferring large quantities of people using cellular devices from one location to another.

However, another major contributor to the increase in the cellular data traffic may be autonomous vehicles and/or partially autonomous vehicles which are monitored and controlled remotely and thus require transfer of large volumes of data over the cellular network(s). While still in their early deployment stages, these autonomous vehicles will become highly common and thus further loading the cellular network infrastructure.

### SUMMARY OF THE INVENTION

According to a first aspect of the present invention there is provided a computer implemented method of predicting a cellular traffic load in a certain geographical area, comprising:
Identifying a plurality of in-motion vehicular cellular devices moving within a certain geographical area deployed with a plurality of network infrastructure apparatuses.
Estimating future locations of the plurality of vehicular cellular devices by predicting a plurality of time series based routes of the plurality of vehicular cellular devices.
Predicting a future cellular traffic load for one or more of the plurality of network infrastructure apparatuses estimated, based on the future locations, to serve at least some of the plurality of vehicular cellular devices by applying a Machine Learning (ML) Model trained, using historical cellular data consumption records, to predict the cellular data consumption of the at least some vehicular cellular devices.
Outputting the predicted future cellular traffic load to one or more management systems configured to initiate one or more actions in advance to optimize cellular traffic management based on the predicted future cellular traffic load.

According to a second aspect of the present invention there is provided a system for predicting a cellular communication traffic load in a certain geographical area, comprising one or more processors executing a code. The code comprising:
Code instructions to identify a plurality of in-motion vehicular cellular devices moving within a certain geographical area deployed with a plurality of network infrastructure apparatuses.
Code instructions to estimate future locations of the plurality of vehicular cellular devices by predicting a plurality of time series based routes of the plurality of vehicular cellular devices.
Code instructions to predict a future cellular traffic load for one or more of the plurality of network infrastructure apparatuses estimated, based on the future locations, to serve at least some of the plurality of vehicular cellular devices by applying Machine Learning (ML) Model trained, using historical cellular data consumption records, to predict a cellular data consumption of the at least some vehicular cellular devices.
Code instructions to output the predicted future cellular traffic load to one or more management systems configured to initiate one or more actions in advance to optimize cellular traffic management based on the predicted future cellular traffic load.

According to a third aspect of the present invention there is provided a computer readable medium comprising program instructions executable by one or more processor, which, when executed by the one or more processor, cause the one or more processor to perform a method according to the first aspect.

In a further implementation form of the first, second and/or third aspects, the plurality time series based routes are estimated using a probabilistic model configured to compute an estimated trajectory for each of the plurality of vehicular cellular devices based on probability scores computed for estimated transitions of the respective vehicular cellular device over road infrastructure identified in the certain geographical area.

In a further implementation form of the first, second and/or third aspects, the positioning of one or more of the plurality of vehicular cellular devices is extracted from positioning information derived from one or more cellular activity records of cellular communication activity in the certain geographical area.

In a further implementation form of the first, second and/or third aspects, the positioning of one or more of the plurality of vehicular cellular devices is extracted from positioning information received from one or more positioning sensors associated with at least vehicular cellular device.

In a further implementation form of the first, second and/or third aspects, the probabilistic model is further configured to correlate between the route estimated for each of the plurality of vehicular cellular devices and one or more of the plurality of network infrastructure apparatuses deployed in the certain geographical area during the travel of the respective vehicular cellular device according to one or more transmission parameters computed for the respective vehicular cellular device with respect to the one or more network infrastructure apparatuses.

In a further implementation form of the first, second and/or third aspects, the estimated trajectory is computed for each of the plurality of vehicular cellular devices based on periodically updated positioning of the respective vehicular cellular device.

In an optional implementation form of the first, second and/or third aspects, the positioning of one or more of the plurality of vehicular cellular devices is estimated in case of unavailability of the updated positioning information for the one or more vehicular cellular devices.

In a further implementation form of the first, second and/or third aspects, the historical cellular data consumption records used the train the ML model comprise a plurality of cellular network activity flows and events indicative of cellular data consumption of a plurality of cellular devices.

In a further implementation form of the first, second and/or third aspects, each of the plurality of cellular network activity flows are preprocessed before fed to the ML model by applying one or more filters to the respective cellular network activity flow.

In a further implementation form of the first, second and/or third aspects, each of the plurality of cellular network activity flows is normalized to map the respective cellular network activity flow in a predefined range.

In a further implementation form of the first, second and/or third aspects, each of the plurality of predicted routes fed to the ML model is further coupled with metadata comprising one or more timing parameters which is a member of a group consisting of: a current time of day and a current day of the week.

In a further implementation form of the first, second and/or third aspects, the historical data is extracted from one or more cellular communication activity records of cellular communication activity in the certain geographical area.

In a further implementation form of the first, second and/or third aspects, one or more of the ML models are utilized by one or more Dilated Convolutional Neural Networks (D-CNN).

In a further implementation form of the first, second and/or third aspects, the D-CNN is constructed of an input layer, twelve convolutional layers, two dense layers and an output layer.

In a further implementation form of the first, second and/or third aspects, a dilation rate of multiplied by a factor of two for each of the twelve convolutional layers compared to its preceding convolutional layer.

In a further implementation form of the first, second and/or third aspects, the D-CNN further comprising one or more dropout layers between a first dense layer of the two dense layers and a second dense layer of the two dense layers.

In a further implementation form of the first, second and/or third aspects, the ML model is trained using a loss function defining a minimal modified Mean Percentage Absolute Error (MPAE), the modified (MPAE) is applied to include in the predicted cellular data consumption only cellular data consumption of each of the at least some vehicular cellular devices which exceeds a predefined threshold.

In a further implementation form of the first, second and/or third aspects, the ML model is optimized during training by applying a Stochastic Gradient Descent (SGD) algorithm.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of predicting future cellular network traffic load in a certain geographical area, according to some embodiments of the present invention;

FIG. 2 is a schematic illustration of an exemplary system for predicting future cellular network traffic load in a certain geographical area, according to some embodiments of the present invention;

FIG. 3 is a schematic illustration of an exemplary probabilistic route prediction model configured for predicting routes of vehicular cellular devices in a certain geographical area, according to some embodiments of the present invention;

FIG. 4 is a schematic illustration of an exemplary ML model created and trained for predicting cellular network traffic load in a certain geographical area, according to some embodiments of the present invention; and

FIG. 5 is a graph chart of an estimation error of an exemplary ML model applied to predict cellular network traffic load in a certain geographical area, according to some embodiments of the present invention.

### DESCRIPTION OF SPECIFIC EMBODIMENTS OF THE INVENTION

The present invention, in some embodiments thereof, relates to optimizing utilization and service of cellular network traffic, and, more specifically, but not exclusively, to optimizing utilization and service of cellular network traffic based on future cellular network traffic load estimated by predicting future locations of in-motion vehicular cellular devices and further predicting their cellular data consumption.

According to some embodiments of the present invention, there are provided systems, methods and computer program products for predicting future cellular network traffic load at one or more cellular network infrastructure apparatuses, for example, a base station, a Node B, an Evolved Node B (eNodeB) and/or the like deployed in a certain geographical area, specifically an outdoor area to serve (provide cellular network connectivity) cellular devices located within their coverage area.

In particular, at least some of the cellular devices present in the certain geographical area and served by the cellular network infrastructure apparatuses are in-motion vehicular cellular devices which are in mobility state, i.e. vehicular cellular devices which move and change locations (positioning) in the certain geographical area.

The in-motion vehicular cellular devices may include mobile cellular devices (e.g., cellphone, tablet, wearable device, etc.) carried by respective users (operators, drivers, passengers) traveling by vehicle (e.g. car, bus, train, tram, motorcycle, bicycle, etc.) and thus moving within the certain geographical area. The in-motion vehicular cellular devices may further include mobile cellular devices which are integrated, mounted, installed and/or otherwise associated with one or more vehicles moving in the certain geographical area, for example, an autonomous vehicle system, a control system, a maintenance system, a safety system, a security system, a navigation system, a multimedia system and/or the like which may communicate with one or more remote networked resources, systems, platforms and/or services.

Two main aspects may affect and influence the cellular network traffic load at the cellular network infrastructure apparatus(s) at one or more future times. The first aspect is the traffic congestion which may affect the overall number of cellular devices, specifically vehicular cellular devices that will be served by each cellular network infrastructure apparatus at the future time(s). The second aspect is the cellular data congestion in terms of network utilization and/or quality of service, for example, network bandwidth, latency and/or the like. The cellular data congestion is a sum or and an aggregation of the cellular data consumption of all of the plurality of served cellular devices.

To address the first affecting aspect, the future locations of the in-motion vehicular cellular devices at the future time(s) may be first estimated in order to predict the number of vehicular cellular devices that will be served by each cellular network infrastructure apparatus at the future time(s). Specifically, the estimated future locations of the vehicular cellular devices may be correlated with the coverage areas of the cellular network infrastructure apparatuses to determine for each cellular network infrastructure apparatus which vehicular cellular devices it will serve. Naturally, the overall number of cellular devices served by each cellular network infrastructure apparatus may include, in addition to the predicted vehicular cellular device(s), one or more stationary (static) cellular devices having a fixed location (positioning) within the coverage area of the respective cellular network infrastructure apparatus.

The future locations of the in-motion vehicular cellular devices may be estimated by predicting a route of each vehicular cellular device which may be structured as a time series based route corresponding to road segments identified in the certain geographical area based on analysis of one or more mapping records of the certain geographical area, for example, a map, a photograph and/or the like. In particular, a probabilistic model may be applied to predict the time series based routes for the plurality of vehicular cellular devices based on transition probabilities of each vehicular cellular device to move (transition) from one location (positioning) to another location. The probabilistic model may compute the transition probabilities based on one or more parameters relating to the road infrastructure in the certain geographical area, for example, intersections, traffic lights, turning points and/or the like.

The predicted routes computed for the vehicular cellular devices, specifically the road segments the vehicular cellular devices are predicted to pass may be correlated with the coverage areas of the cellular network infrastructure apparatuses. Therefore, based on the future location of each vehicular cellular device at the future time(s), a respective cellular network infrastructure apparatus may be estimated to serve the respective vehicular cellular device.

To address the second affecting aspect, the future cellular data consumption of each of the cellular devices served by each of the cellular network infrastructure apparatuses may be estimated. Specifically, the future cellular data consumption may be predicted using one or more Machine Learning models (ML), for example, a neural network such as, for example, a Convolutional Neural Network (CNN), a Fully Connected (FC) neural network, a Feed-Forward (FF) neural network, a Recurrent Neural Network (RNN) and/or the like. Moreover, the ML model may be utilized by a Dilated CNN (D-CNN).

The ML model may be trained using historical cellular data consumption records captured for cellular network infrastructure apparatuses in general and for the cellular network infrastructure apparatuses deployed in the certain geographical area in particular. Since such historical data is highly available, the training dataset used for training and learning the ML model may be highly extensive and diverse. This may enable training the ML model to achieve very high prediction performance while preventing overfitting.

The overall future cellular network traffic load may be then estimated for each cellular network infrastructure apparatus based on the number of cellular devices estimated to be served by the respective cellular network infrastructure apparatus including the vehicular cellular devices predicted to be located in the coverage area of the respective cellular network infrastructure apparatus and on the estimated cellular data consumption of these cellular devices.

The estimated future cellular network traffic load may be provided to one or more cellular network management systems which may initiate one or more actions to optimize the cellular traffic management, for example, improve utilization of the cellular network, improve service of the cellular network, reduce latency of the cellular network traffic and/or the like.

According to some embodiments of the present invention, the cellular traffic load prediction may be applied to recommend a preferred route estimated to support best cellular network serviceability for one or more of the vehicles hosting one or more vehicular cellular devices. This means that, based on the predicted cellular traffic load at one or more of the cellular network infrastructure apparatuses, a recommended route associated with less loaded cellular network infrastructure apparatuses may be identified and transmitted to one or more of the vehicles hosting vehicular cellular devices. Selecting the recommended route may ensure a relatively high cellular network quality of service.

Accurately predicting the future cellular network traffic load may present major benefits and advantages compared to existing methods and systems for managing cellular and/or network traffic.

First, accurately estimating the future cellular network traffic at one or more of the cellular network infrastructure apparatuses may enable the cellular network management system(s) to take one or more actions in advance in order to accommodate the expected cellular network traffic while maintaining high quality of service for the served cellular devices. For example, the cellular network management system(s) may apply one or more load balancing measures at cellular network infrastructure apparatuses expected to be highly loaded. For example, the cellular network management system(s) may increase transmission power of one or more cellular network infrastructure apparatuses adjacent to the highly loaded cellular network infrastructure apparatus(s). As such, the adjacent cellular network infrastructure apparatus(s) may serve at least some of the cellular devices expected to be located within the coverage area of the highly loaded cellular network infrastructure apparatus(s) thus reducing the cellular network traffic load at the highly loaded cellular network infrastructure apparatus(s). In another example, the cellular network management system(s) may redirect traffic planned to be relayed through highly loaded cellular network infrastructure apparatus(s) to other less loaded cellular network infrastructure apparatus(s) thus further reducing the cellular network traffic load at the highly loaded cellular network infrastructure apparatus(s).

Ensuring a high quality of service may be essential for a plurality of applications, in particular for autonomous and/or partially autonomous vehicles which may need to exchange vast amounts of data with remote networked resources via the cellular network.

Moreover, applying the probabilistic model to predict the time series based routes of the in-motion vehicular cellular devices based on the transition probabilities according to the road infrastructure may significantly increase the accuracy of the estimated future location of the in-motion vehicular cellular devices. This, in turn, may significantly increase the prediction accuracy of the expected future cellular network traffic load at the cellular network infrastructure apparatuses whose coverage area overlaps these estimated future locations.

Furthermore, predicting the cellular network traffic load at the cellular network infrastructure apparatus may enable identifying routes which may pass though coverage areas of less loaded cellular network infrastructure apparatuses thus ensuring a high quality of service of the cellular network while traveling along these routes. These high quality of service routes may be recommended to one or more vehicles hosting vehicular cellular devices which may thus enjoy high quality of service while moving and travelling through the certain geographical area. This may be of particular benefit to autonomous vehicles and/or partially autonomous vehicles which may require high quality of service, for example, high bandwidth, low latency and/or the like for monitoring and/or controlling their operation.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

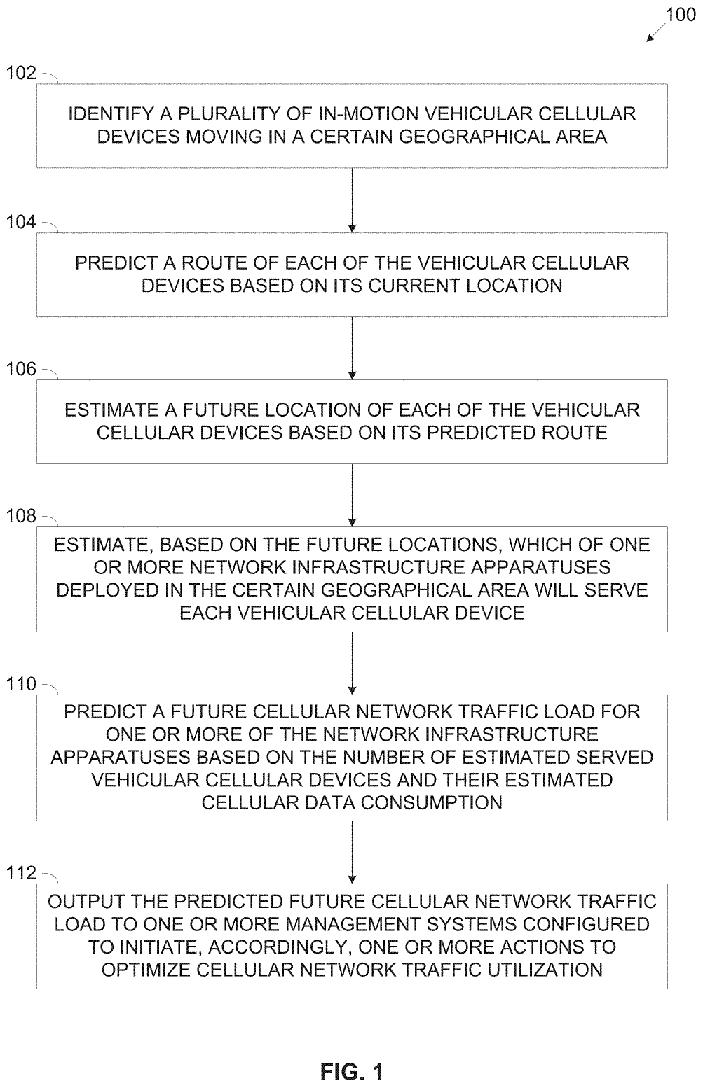

Referring now to the drawings, FIG. 1 is a flowchart of an exemplary process of predicting future cellular network traffic load in a certain geographical area, according to some embodiments of the present invention.

An exemplary process 100 may be executed to predict a future cellular network traffic load on one or more cellular network infrastructure apparatuses, for example, a base station, a Node B, an Evolved Node B (eNodeB) deployed in a certain geographical area to serve cellular devices located within their coverage area.

At least some of the cellular devices are vehicular cellular devices, for example, cellular devices installed in a vehicle (e.g. car, train, bus, tram, etc.), a cellular device used by a user riding a vehicle (e.g. a driver, a passenger, etc.) and/or the like. Some of the vehicular cellular devices may be therefore in mobility state, i.e. in-motion and moving within the certain geographical area.

The process 100 may be thus executed to predict two aspects affecting the future cellular network traffic load on the cellular network infrastructure apparatus(s).

First, the future locations of the in-motion vehicular cellular devices may be estimated in order to estimate the number of vehicular cellular devices that will be served by each cellular network infrastructure apparatus. The served vehicular cellular devices may be added to static and stationary cellular devices also served by the respective cellular network infrastructure apparatus. In particular, the future cellular network traffic load may be estimated per road segments in the certain geographical area identified by analyzing one or more mapping records of the certain geographical area, for example, a map, a photograph and/or the like.

Second, the cellular data consumption of each of the cellular devices served by the respective cellular network infrastructure apparatus may be estimated, for example, using one or more ML models (e.g. neural network, etc.).

The overall future cellular network traffic load may be then estimated based on the number of served cellular devices and their estimated cellular data consumption.

The estimated future cellular network traffic load may be provided to one or more cellular network management systems which may initiate one or more actions to optimize the cellular traffic management, for example, improve utilization of the cellular network, improve service of the cellular network, reduce latency of the cellular network traffic and/or the like.

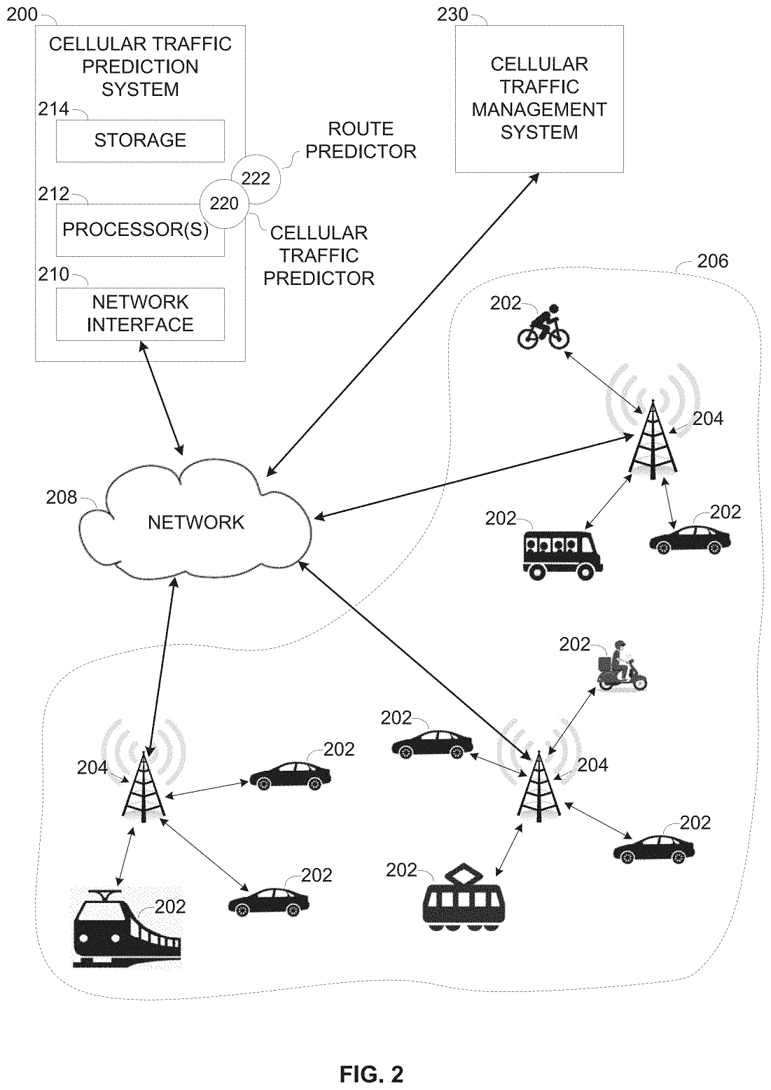

Reference is also made to FIG. 2, which is a schematic illustration of an exemplary system for predicting future cellular network traffic load in a certain geographical area, according to some embodiments of the present invention.

An exemplary cellular traffic prediction system 200, for example, a computer, a server, a computing node, a cluster of computing nodes and/or the like may be deployed to execute a process such as the process 100 for predicting a future cellular network traffic load on one or more cellular network infrastructure apparatuses 204, for example, a base station, a Node B, an Evolved Node B (eNodeB) deployed in a certain geographical area 206 to serve a plurality of cellular devices located within their coverage area.

As such, the cellular network infrastructure apparatuses 204 may provide the served cellular devices located connectivity to cellular network for further connecting to a network 208 comprising one or more wired and/or wireless networks, for example, a Local Area Network (LAN), a Wireless Local Area Network (WLAN), a Wide Area Network (WAN), a Municipal Area Network (MAN), a cellular network, the internet and/or the like.

The plurality of cellular devices located (present) in the certain geographical area 206 which may be an outdoor area, for example, a city, a suburb, a district, a neighborhood, a town and/or the like may include a plurality of vehicular cellular devices 202 which may be in mobility state (in-motion), i.e. move within the certain geographical area 206 and transition from one location to another.

The vehicular cellular devices 202 may include, for example, cellular devices installed in one or more vehicles, for example, a car, a truck, a motorcycle, a bicycle, a train, a bus, a tram and/or the like. Such cellular devices may include for example, a cellular device deployed in the vehicle to provide connectivity to an autonomous vehicle control system. In another example, the vehicular cellular devices 202 deployed in the vehicle may serve to provide one or more services to the vehicle and/or to one or more passengers in the vehicle, for example, a navigation service, a media service (audio, video, data, etc.), a maintenance service, an emergency service and/or the like. In another example, the vehicular cellular devices 202 may include cellular devices used (and carried) by users (drivers, passengers) riding in one or more vehicles.

The cellular traffic prediction system 200 may include a network interface 210, a processor(s) 212 and a storage 214 for program code store and/or data store.

The network interface 210 may include one or more wired and/or wireless network and/or communication interfaces for connecting to the network 206. Via the network interface 210, the cellular traffic prediction system 200 may communicate with one or more cellular network management and/or monitor systems 230, for example, a network switch, a Radio Area Network (RAN) controller and/or with one or more of the cellular network infrastructure apparatuses 204 to collect cellular network activity information extracted from one or more cellular activity records, for example, a Charging Data Record (CDR), a Call Trace Record (CTR), an Event Detail Record (EDR) and/or the like.

Moreover, the cellular traffic prediction system 200 may further communicate via the network interface 210 with one or more of the cellular network management systems 230 to provide the future cellular network traffic load estimated for one or more of the cellular network infrastructure apparatuses 204 to enable the cellular network management system(s) 230 to initiate one or more actions to optimize the cellular traffic management, for example, improve utilization of the cellular network, improve service of the cellular network, reduce latency of the cellular network traffic and/or the like

The processor(s) 212, homogenous or heterogeneous, may include one or more processors arranged for parallel processing, as clusters and/or as one or more multi core processor(s). The storage 214 may include one or more non-transitory persistent storage devices, for example, a Read Only Memory (ROM), a Flash array, a hard drive and/or the like. The storage 214 may also include one or more volatile devices, for example, a Random Access Memory (RAM) component, a cache memory and/or the like. The storage 214 may further include one or more network storage resources, for example, a storage server, a network accessible storage (NAS), a network drive, a cloud storage and/or the like accessible via the network interface 210.

The processor(s) 212 may execute one or more software modules such as, for example, a process, a script, an application, an agent, a utility, a tool, an Operating System (OS) and/or the like each comprising a plurality of program instructions stored in a non-transitory medium (program store) such as the storage 214 and executed by one or more processors such as the processor(s) 212. The processor(s) 212 may further include, integrate and/or utilize one or more hardware modules, for example, a circuit, a component, an Integrated Circuit (IC), an Application Specific Integrated Circuit (ASIC), a Field Programmable Gate Array (FPGA), a Digital Signals Processor (DSP), an Artificial Intelligence (AI) accelerator and/or the like.

The processor(s) 212 may therefore execute one or more software modules, for example, a cellular traffic predictor 220, a route predictor 222 and/or the like for executing the process 100 which may optionally utilize one or more of the hardware modules.

Optionally, the cellular traffic prediction system 200, specifically the cellular traffic predictor 220 and the route predictor 222 may be implemented as one or more cloud computing services, for example, an Infrastructure as a Service (IaaS), a Platform as a Service (PaaS), a Software as a Service (SaaS) and/or the like deployed over one or more cloud computing platforms such as, for example, Amazon Web Service (AWS), Google Cloud, Microsoft Azure and/or the like.

As shown at 102, the process 100 starts with identifying one or more of the vehicular cellular devices 202 which are in-motion, i.e., in mobility state and moving within the certain geographical area 206. This step may be executed, for example, by the cellular traffic predictor 220 executed by the cellular traffic prediction system 200.

While some of the cellular devices present in the certain geographical area 206 may be static and/or stationary having a fixed and known location (positioning), at least some of the cellular devices, specifically, one or more of the vehicular cellular devices 202 may be in mobility state. The cellular traffic predictor 220 may therefore identify the vehicular cellular devices 202 which are in mobility state by identifying the positioning of the cellular devices present in the certain geographical area 206, specifically changes in the positioning which may indicate of the vehicular cellular devices 202 which are in-motion and transition from one location (position) to another.

The cellular traffic predictor 220 may identify the positioning of the in-motion vehicular cellular devices 202 by analyzing data collected in the certain geographical area 206.

The collected data analyzed by the cellular traffic predictor 220 may include one or more of the cellular activity records comprising the cellular network activity information. For example, the cellular traffic predictor 220 may analyze data extracted from one or more CDRs produced by one or more cellular network switches managing cellular network traffic for the cellular devices located in the certain geographical area 206. In another example, the cellular traffic predictor 220 may analyze data extracted from one or more CTRs collected by one or more RAN probes (controllers) processing a control plane of the cellular network. In another example, the cellular traffic predictor 220 may analyze data extracted from one or more EDRs collected by one or more internet gateway probes (controllers) processing a data plane of the cellular network. In another example, the cellular traffic predictor 220 may analyze telemetry data received from one or more of the vehicles which contains one or more radio transmission measurements.

The collected data analyzed by the cellular traffic predictor 220 may further include positioning information received from one or more positioning sensors, systems and/or devices associated with one or more of the vehicular cellular devices 202, for example, Global Positioning System (GPS) information, speed, acceleration, direction information and/or the like. The positioning information may be received, for example, in form of cellular antenna geographical attributes and/or estimated latitude-longitude position of one or more cellular events, for example, a service event, a hand-off event and/or the like. The antenna geographical attributes and/or estimated latitude-longitude position of one or more cellular events may be pre-calculated using one or more geo-location computation methods as known in the art based on one or more raw radio trace event records.

Based on the analysis, the cellular traffic predictor 220 may extract a plurality of flows for each of the cellular network infrastructure apparatuses 204 deployed in the certain geographical area 206. The cellular traffic predictor 220 may extract a plurality of flows relating to the network activity of the cellular devices served by the cellular network infrastructure apparatuses 204 in the certain geographical area 206.

The flows may include parameters, events, attributes and/or the like relating to the activity of the cellular network at each of one or more of the cellular network infrastructure apparatuses 204. One or more of the flows may include, for example, one or more counter parameters, for example, a number of distinct cellular devices connected to the respective cellular network infrastructure apparatus 204, a number of end call, a number of start call, a number of downloaded bytes, a number of uploaded bytes, an amount of talk time (seconds), a data duration (seconds), a number of voice drops and/or the like. In another example, one or more of the flow may further include one or more user experience parameters, for example, a number of low quality calls, a number of data problems, a number of data downgrade to 2G, a number of data downgrade to 3G and/or the like. One or more of the flows may further include one or more transition (hand-off) events in which one or more of the cellular devices present and served in the certain geographical area 206 are transferred, i.e. handed over between adjacent cellular network infrastructure apparatuses 204.

The cellular traffic predictor 220 may further analyze data collected in the certain geographical area 206 during a time window of a predefined time period, for example, 5 minutes, 10 minutes, 15 minutes and/or the like.

The CDRs may include information indicative of the positioning of one or more of the cellular devices present in the certain geographical area 206 which may be used by the cellular traffic predictor 220 to identify one or more of the vehicular cellular devices 202 and their current positioning (location). For example, the cellular traffic predictor 220 may analyze hand-off information extracted from one or more of the cellular activity records to identify one or more cell transition (hand-off) events of one or more of the vehicular cellular devices 202 which indicates these vehicular cellular devices 202 are in motion and changing location (positioning), i.e., in mobility state. In another example, the cellular traffic predictor 220 may analyze the number of cellular devices registered for service by each of the cellular network infrastructure apparatuses 204 over a predefined time period to identify transitions of one or more of the vehicular cellular devices 202 from one cellular network infrastructure apparatus 204 to another.

The cellular traffic predictor 220 may also identify one or more of the vehicular cellular devices 202 based on mobility patterns identified for the respective vehicular cellular devices 202 previous to the current time, for example, in the past 30 minutes, in the past 15 minutes, in the past 10 minutes and/or the like.

Moreover, the cellular traffic predictor 220 may identify one or more of the cellular devices present in the certain geographical area 206 to be a vehicular cellular device 202 by definition, for example, a vehicle installed and/or a vehicle mounted cellular device. The cellular traffic predictor 220 may analyze an identifier (ID) of one or more such vehicular cellular devices 202, for example, an International Mobile Subscriber Identity (IMSI) number and/or the like and detect one or more cellular devices having IMSIs predefined as vehicle installed and/or mounted cellular device which may be thus an in-motion vehicular cellular device 202.

The cellular traffic predictor 220 may extract and store flows relating to all cellular devices present in the certain geographical area 206 which are served by the cellular network infrastructure apparatuses 204 and among the plurality of flows mark flows which relate to the identified in-motion vehicular cellular devices 202.

Based on the analysis of the flows, the cellular traffic predictor 220 may determine the location (positioning) of the identified in-motion vehicular cellular devices 202.

As shown at 104, the cellular traffic predictor 220 may predict a route of each of the identified in-motion vehicular cellular devices 202. In other words, the cellular traffic predictor 220 may predict and/or infer which route each of the identified in-motion vehicular cellular devices 202 may follow within the certain geographical area 206 during a predefined time period. The inference may be performed by the cellular traffic predictor 220 in an online fashion, where the route history is saved until the cellular traffic predictor 220 receives the next observation upon which the route trace may be then updated.

To this end, the cellular traffic predictor 220 may use the route predictor 222 which may utilize a probabilistic route prediction model configured to compute an estimated trajectory for each of the plurality of vehicular cellular devices 202 based on probability scores computed for estimated transitions of the respective vehicular cellular device 202 over road infrastructure identified in the certain geographical area 206. In particular, using the probabilistic model, the route predictor 222 may compute a plurality of time series based routes of the plurality of vehicular cellular devices 202 where each time series based route includes a plurality of transitions selected according to their computed probability score.

The route predictor 222 may obtain mapping data of the certain geographical area 206. The mapping data may include one or more maps, for example, a geographical map, a road map, a topographic map and/or the like. The mapping data may further include one or more photographs depicting the certain geographical area 206 and/or part thereof. The photographs may include, for example, ground level photograph, aerial photograph captured by one or more aerial vehicles and/or drones, satellite photographs and/or the like.

The mapping data may be provided, embedded and/or otherwise utilized by the probabilistic model to compute the probability scores for the transitions of each of the vehicular cellular devices 202 and create their time series based routes accordingly.

The cellular traffic predictor 220 may receive additional, updated data collected for the vehicular cellular devices 202 and may periodically and/or continuously update the positioning of one or more of the identified in-motion vehicular cellular devices 202. The route predictor 222, using the probabilistic model, may therefore compute updated probability scores for the transitions estimated for one or more of the vehicular cellular devices 202 based on the updated positioning of the respective vehicular cellular device 202 and may update the predicted time series based routes accordingly. For example, the route predictor 222, using the probabilistic model, may create an additional segment in the time series based routes predicted for one or more of the in-motion vehicular cellular devices 202 every predefined time period, for example, every 5 minutes, every 10 minutes, every 15 minutes and/or the like.

However, there may be cases and scenarios in which updated positioning information is no available for one or more of the vehicular cellular devices 202. In such case, the route predictor 222, using the probabilistic model, may estimate the positioning (location) of this vehicular cellular device(s) 202 for which no updated positioning information is available. The route predictor 222, using the probabilistic model, may estimate the positioning (location) of each such vehicular cellular device 202 based, for example, on typical vehicle speed along the predicted route, an identified speed of the vehicle hosting the respective vehicular cellular device 202, number of turning points along the predicted route which may delay the advancement of the hosting vehicle and/or the like. The route predictor 222, using the probabilistic model, may further update and/or adjust the probability scores computed for the transitions estimated for one or more of the vehicular cellular devices 202 based on the estimated positioning of the respective vehicular cellular device 202 and may update the predicted time series based routes accordingly.

Moreover, the route predictor 222, using the probabilistic model, may update the time series based routes predicted for one or more of the vehicular cellular devices 202 according to one or more road and/or traffic attributes identified along the predicted route of the respective vehicular cellular devices 202. For example, the route predictor 222, using the probabilistic model, may update the route predicted for one or more of the vehicular cellular devices 202 according to one or more intersections that the respective vehicular cellular device 202 is estimated to cross in which the respective vehicular cellular device 202 may take one of a several paths. In another example, the route predictor 222, using the probabilistic model, may update the route predicted for one or more of the vehicular cellular devices 202 to include time delays resulting from one or more traffic lights that the respective vehicular cellular device 202 is estimated to pass.

The cellular traffic predictor 220 and/or the route predictor 222 may further receive additional data, for example, metadata relating to one or more conditions applicable to the certain geographical area 206 and/or part thereof which may impact the travel time of one or more of the vehicles hosting one or more of the vehicular cellular devices 202 and therefore may require the route predictor 222 to adjust the predicted time series based routes. Such metadata may include, for example, timing data comprising one or more timing parameters, for example, a current time, a current day of week and/or the like. The metadata may further include one or more traffic parameters relating the roads and/or traffic in the certain geographical area 206, for example, typical traffic load at different times of the day, typical traffic load at different days of the week of the week, a waiting time at one or more of traffic lights and/or the like. The metadata may also include one or more weather conditions currently applicable for the certain geographical area 206, for example, rain, snow, hail, fog and/or the like.

The route predictor 222, using the probabilistic model, may therefore update and/or adjust the route predicted for one or more of the vehicular cellular devices 202 based on the received metadata. For example, assuming heavy traffic is expected along the predicted path of one or more of the vehicular cellular devices 202, the route predictor 222 may increase the travel (advancement) time of the respective vehicular cellular device 202. Optionally, the route predictor 222 may estimate that due to the heavy traffic along the route initially predicted for one or more of these vehicular cellular devices 202, the vehicle hosting the respective vehicular cellular device 202 may take a different less crowded route and may adjust accordingly the time series based route predicted for the respective vehicular cellular device 202. In another example, assuming heavy rain is expected in the area of the predicted route of one or more of the vehicular cellular devices 202, the route predictor 222 may increase the travel time of the respective vehicular cellular device 202.

The cellular traffic predictor 220 may further associate between the predicted time series based routes of the vehicular cellular devices 202 and the cellular network infrastructure apparatuses 204 deployed along these predicted routes which are thus estimated to serve the vehicular cellular devices 202. The association may be done based on the road segments included in the predicted time series based routes and the location (position) of the cellular network infrastructure apparatuses 204.

In particular, the cellular traffic predictor 220 may associate between the routes predicted for each of the vehicular cellular devices 202 and one or more of the cellular network infrastructure apparatuses 204 according to one or more transmission parameters computed for the respective vehicular cellular device 202, specifically with respect to the respective cellular network infrastructure apparatus 204. The transmission parameters may include, for example, a maximal effective transmission range of the respective vehicular cellular device 202, a communication protocol (2G, 3G, 4G, 5G, etc.) supported by the respective vehicular cellular device 202, an error recovery protocol and/or algorithm employed by the respective vehicular cellular device 202 and/or the like. For example, assuming the transmission range (distance) of a certain vehicular cellular device 202 is significantly high, the cellular traffic predictor 220 may associate the certain vehicular cellular device 202 with one or more cellular network infrastructure apparatuses 204 located significantly far from the predicted route of the certain vehicular cellular device 202 but with the maximum transmission range of the certain vehicular cellular device 202. In contrast, assuming the transmission range the certain vehicular cellular device 202 is significantly low, the cellular traffic predictor 220 may associate the certain vehicular cellular device 202 only with cellular network infrastructure apparatuses 204 which are located significantly close to the route predicted for the certain vehicular cellular device 202.

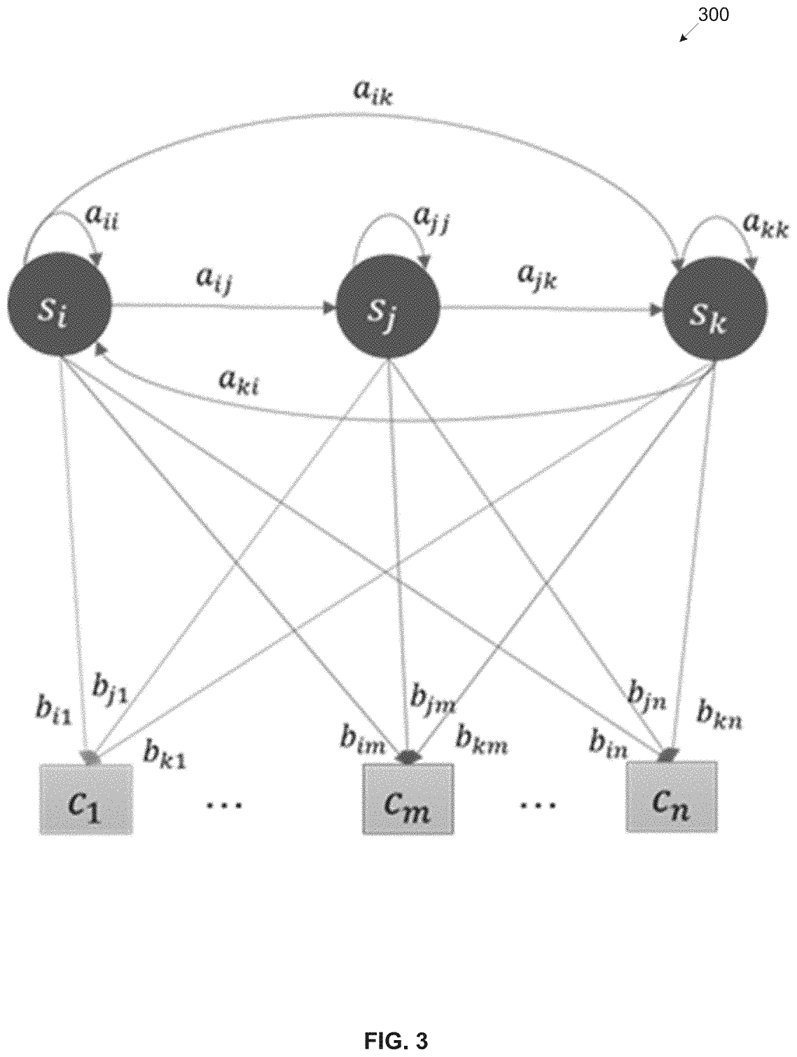

Reference is now made to FIG. 3, which is a schematic illustration of an exemplary probabilistic route prediction model configured for predicting routes of vehicular cellular devices such as the vehicular cellular devices 202 in a certain geographical area such as the certain geographical area 206, according to some embodiments of the present invention.

An exemplary graphical probabilistic route prediction model 300 used by a route predictor such as the route predictor 222 may be denoted by a Hidden Markov Model (HMM). The mapping information, specifically the road infrastructure mapping of the certain geographical area 206 may be embedded in the graphical probabilistic model 300 by a plurality of model states sᵢ . . . sₖ corresponding respectively to a plurality of road segments in the certain geographical area 206 with the direction of these road segments.

A transition probability aᵢⱼ(Δt, Δsᵢⱼ, . . . ) denotes the probability of a vehicular cellular device 202 to transition from state sᵢ to state sⱼ. The transition probability aᵢⱼ(Δt, Δsᵢⱼ, . . . ) may depend on one or more parameters, for example, a time-difference between observations (Δt) of the vehicular cellular device 202, a travel distance between segments (Δsᵢⱼ), one or more speed limits along the transitions, one or more delays due to turning points, traffic lights, and/or the like.

The probabilistic model 300 may associate each of the states sᵢ . . . sₖ corresponding to the road segments in the certain geographical area 206 with one or more cellular network infrastructure apparatuses such as the cellular network infrastructure apparatuses 204 deployed in the certain geographical area 206.

A plurality of observations c₁ . . . cₙ denote a series of n observed cellular network infrastructure apparatuses 204 with corresponding time stamps.

The probabilistic model 300 may compute a probability score bᵢₘ of a vehicular cellular device 202 being in a state sᵢ when observed at cₘ corresponding to a cellular network infrastructure apparatus 204 m at a certain time according to the formulation bᵢₘ(Δxyzₘ, Δθₘ, Δφₘ, fₘ, pwrₘ, . . . ). This formulation expresses the dependency of the probability score bᵢₘ on one or more parameters, for example, a distance Δxyzₘ between the cellular network infrastructure apparatus 204 m and the road segment i, a bearing difference Δθₘ from the main lobe of the cellular network infrastructure apparatus 204 m, an elevation difference Δφₘ from the main lobe of the cellular network infrastructure apparatus 204 m, a transmission frequency fₘ of the cellular network infrastructure apparatus 204 m, a transmission power pwrₘ of the cellular network infrastructure apparatus 204 m, a transmission power pwrₗ of one or more other cellular network infrastructure apparatuses 204 l and/or the like.

The time series based routes may be therefore predicted by the route predictor 222 by searching the most probable path in the graphical probabilistic model 300 given a series of observations of the vehicular cellular devices 202 with respect to the cellular network infrastructure apparatuses 204. For example, given a route (path) on the road segments the route predictor 222 algorithm may extract the average speed of the vehicle hosting the respective vehicular cellular device 202 at each time by dividing the accumulated distance (sum) around a certain time stamp by the corresponding time difference. After extracting and computing the predicted path and the average speed for the respective vehicular cellular device 202, the route predictor 222 may determine whether the respective vehicular cellular device 202 is stationary or in-motion (moving) by matching the average speed to a certain threshold. The cellular traffic predictor 220 may use this determination, i.e., tagging of stationary/in-motion to mark the flows and events relating to the in-motion (mobility-state) vehicular cellular devices 202.

As shown at 106, based on the time series based route predicted for each of the vehicular cellular devices 202, the cellular traffic predictor 220 may estimate a future location of the respective vehicular cellular device 202 at one or more future times (time horizon).

As shown at 108, based on the estimated future locations of the vehicular cellular devices 202, the cellular traffic predictor 220 may estimate which of the cellular network infrastructure apparatuses 204 will serve, i.e., provide cellular network connectivity to, each of the vehicular cellular devices 202 in each of the future time(s). In other words, the cellular traffic predictor 220 may correlate each of the vehicular cellular device 202 with one or more of the cellular network infrastructure apparatuses 204 estimated to serve the respective vehicular cellular device 202 at the respective future time based on the estimated future location of the respective vehicular cellular device 202.

The cellular traffic predictor 220 may perform the correlation by identifying and/or computing which of the cellular network infrastructure apparatuses 204 has a coverage area that encompasses the estimated future location of each of the vehicular cellular devices 202 at one or more of the future times, for example, in 10 minutes from now, in 15 minutes from now, in 30 minutes from now and so on. This is since in order for a certain cellular network infrastructure apparatus 204 to serve a certain vehicular cellular device 202, the certain vehicular cellular device 202 must be in the coverage area of the certain cellular network infrastructure apparatus 204. Moreover, in order to verify the correlation, even if the certain vehicular cellular device 202 in within the coverage area of the certain cellular network infrastructure apparatus 204, the cellular traffic predictor 220 may further ensure that the transmission parameters of the certain vehicular cellular device 202 are sufficient and/or adequate for communicating with the certain cellular network infrastructure apparatus 204.

As shown at 110, the cellular traffic predictor 220 may predict a future cellular traffic load at one or more of the cellular network infrastructure apparatuses 204 based on the number of cellular devices (stationary and in-motion) estimated to be served by the respective cellular network infrastructure apparatus 204 and an estimated cellular data consumption of each of these served cellular devices. The cellular traffic predictor 220 may determine the number of cellular devices estimated based on the estimated future location of the vehicular cellular devices 202 and their correlation with the cellular network infrastructure apparatuses 204.

In particular, in order to predict the future cellular traffic load, the cellular traffic predictor 220 may apply an ML model, for example, a neural network such as, for example, a CNN, an FC neural network, an FF neural network, an RNN and/or the like. In particular, the ML model may be utilized by a Dilated-CNN (D-CNN).

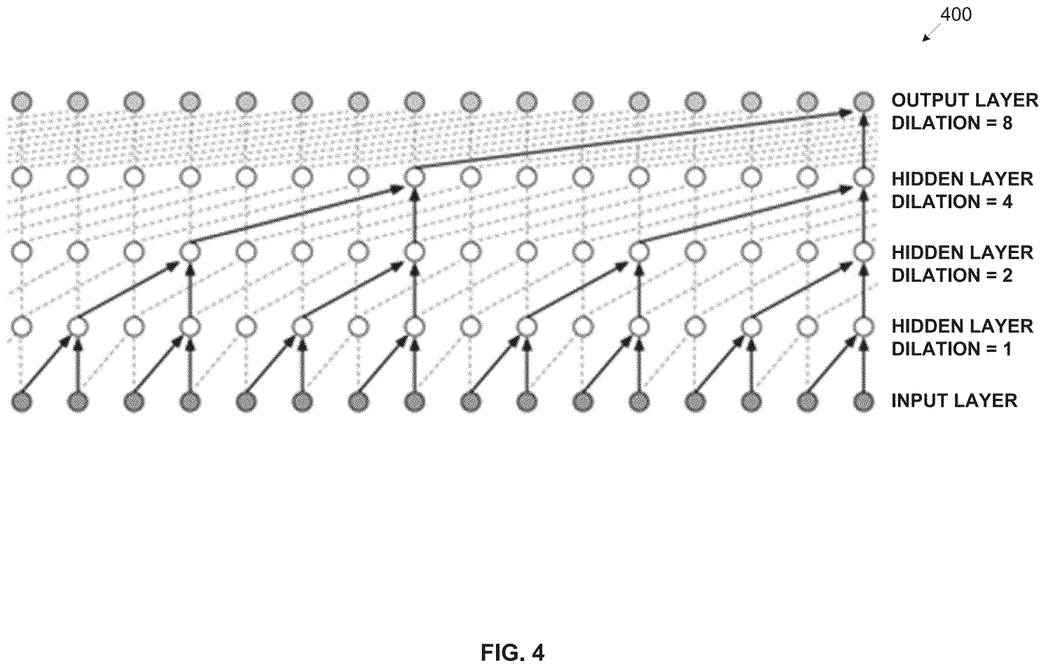

Reference is now made to FIG. 4, which is a schematic illustration of an exemplary ML model created and trained for predicting cellular network traffic load in a certain geographical area, according to some embodiments of the present invention.

An exemplary D-CNN 400 may be utilized as the ML model by a cellular traffic predictor such as the cellular traffic predictor 220 for predicting the future cellular traffic load at one or more cellular network infrastructure apparatuses such as the cellular network infrastructure apparatuses 204 serving a plurality of cellular devices including in-motion vehicular cellular devices such as the vehicular cellular devices 202.

As seen, the D-CNN 400 may include an input layer, 4 dilated-convolutional layers and an output layer where each dilated layer of the network uses 32 convolution filters of size 2. On top of the last dilated convolution layer the D-CNN 400 may include two dense layers to output the predicted signal. The first dense layer may contain 256 hidden neurons followed by a ‘ReLU’ activation. The second dense layer may transform the output of the 256 neurons of the previous dense layer into the predicted signal. For a 3-channel input signal the predicted output would be a 1-channel signal.

Optionally, in order to achieve a more robust parameter optimization, the D-CNN 400 may utilize a regularization approach in the form of a dropout layer located after the first dense layer in the D-CNN model 400.

In another example, the D-CNN may be constructed to include 12 convolutional layers where in each following layer the time-dilation rate is multiplied by factor of 2 (starting from 1). Hence, for 12 convolutional layers the dilation rates are given by [1, 2, 4, 8, 16, 32, 64, 128, 256, 512, 1024, 2048], respectively. In that case, the model's “receptive length” (backward history lookup range) of the 12 layers D-CNN is 2¹¹=2048. For time-series with 15-minute sampling period, 2048 samples refer to approximately 21.33 days of historical data.

The ML model may be trained in advance to predict the estimated cellular data consumption of each of these served cellular devices including the vehicular cellular devices 202. The neural network may be trained, as known in the art, using historical cellular data consumption records, which may include a plurality of past cellular network activity flows (signals) indicative of cellular data consumption of a plurality of cellular devices. As described herein before for the flows, the past flows may include parameters, events, attributes and/or the like relating to past activity of the cellular network at each of one or more of the cellular network infrastructure apparatuses 204. The data included in the past flows, for example, the number of end call, the number of start call, the number of downloaded bytes, the number of uploaded bytes, the amount of talk time, the data duration, the number of voice drops and/or the like may be highly indicative of the past cellular network activity, in particular with respect to past cellular data consumption.

The ML model may be designed as a “general flow predictor” which does not require the knowledge of the source cellular network infrastructure apparatuses 204 or the vehicular cellular devices 202 that generated the flow. The ML model may therefore generate outputs predicting the future cellular traffic load for any input flow history without knowing the identity of the source.

During the training phase (learning process) of the ML model, for example, the D-CNN, training data may be generated based on the past flows. In order to maintain the generality of the ML model and prevent over fitting to a certain dataset, the training data is extracted from cellular data consumption historical record selected for a significantly large set of cellular network infrastructure apparatuses 204. A mini-batch of training samples selected from the training sets may be used in each of the training steps (iterations). The training samples of each min-batch may be selected by a repeated drawing operation, first by choosing the flow (signal) source, and then by a random access of a starting time point. Such a mini-batch may contain, for example, few hundreds to few thousands of samples. The selection of source for each training sample is performed by a cyclic access to the set of sources until the mini-batch data set is completed. As stated herein before, the ML model is not provided with any information regarding the identity of the source cellular network infrastructure apparatuses 204 from which the training samples are derived.

Each input training flow (signal) may be provided as a time series of the events, parameters and/or attributes of the respective flow, updated every pre-defined time period, for example, every 5 minutes, every 10 minutes, every 15 minutes and/or the like. Moreover, each input flow may be preprocessed, i.e., passed through a preprocessing smoothing filter to reduce signal noise. For example, each flow may be convolved with one or more filters, for example, a smoothing filter assigned with the following coefficients: h[n]=[0.1, 0.2, 0.4, 0.2, 0.1] as follows:

Furthermore, each of the preprocessed input training flows (signals), x[n], may be normalized to map the respective cellular network activity flow in a predefined range. For example, the preprocessed input flows x[n] may be normalized using a min-max scaler which transforms signal values to be in the range of [0,1] before going into the ML model.

Complementary, at the final prediction stage, the output signals coming out of the ML model may be re-scaled back (inverse scaling) to their nominal range.

Optionally, the input training flows are provided to the ML model with at least part of the metadata, for example, the timing data comprising one or more of the timing parameters, for example, the current time, the current day of week and/or the like. Each input flow (signal) may be concatenated with a time orientation metadata comprising, for example, the weekday (wd) in a discrete value in a range {0, 1, 2, 3, 4, 5, 6}, and the time-of-day (tod) in hours, in a continuous interval [0,24].

Hence, the input layer to the ML model may be in a form of a time series with 3 channels as follows:

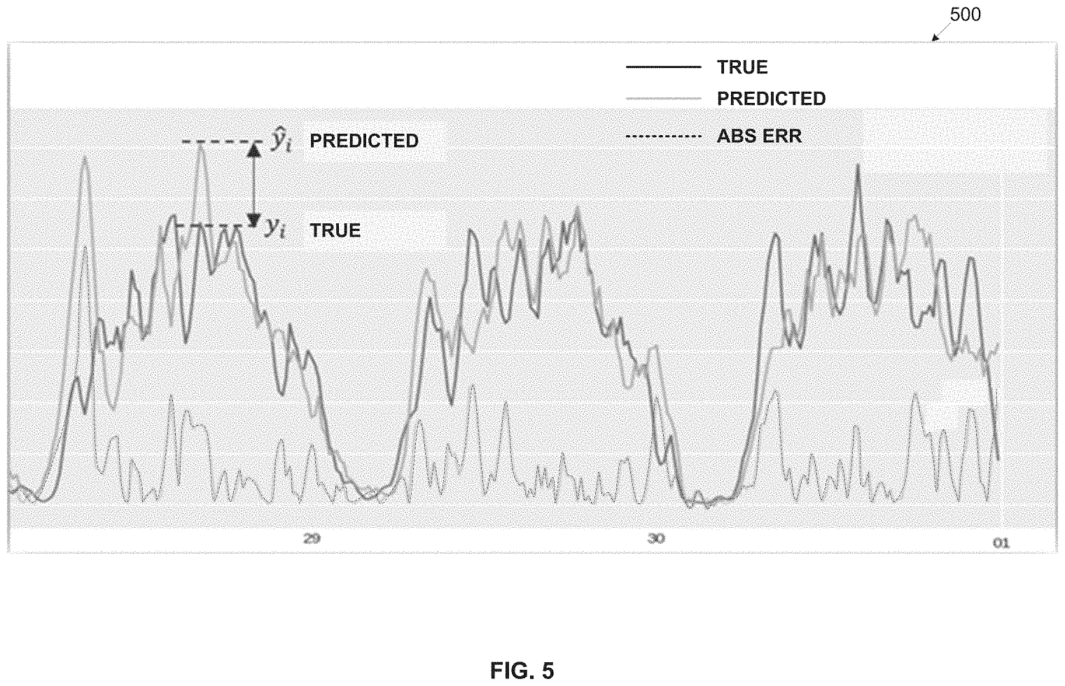

Reference is now made to FIG. 5, which is a graph chart of an estimation error of an exemplary ML model applied to predict cellular network traffic load in a certain geographical area, according to some embodiments of the present invention.

A graph chart 500 presents real (true) cellular traffic load yᵢ over time at a certain cellular network infrastructure apparatus 204 compared to predicted cellular traffic load ŷᵢ computed by the ML model used by a cellular load predictor such as the cellular load predictor 220 for the certain cellular network infrastructure apparatus 204. A Mean Absolute Error (MAE) may be defined by mean |eᵢ|=ŷᵢ−yᵢ and a Mean Percentage Absolute Error (MPAE) reflecting the prediction error may be defined by

$$mean ( \frac{\vert {e}_{i} \vert}{\vert {y}_{i} \vert} ) .$$

The ML model may be therefore trained using one or more loss functions to minimize the prediction error, for example, a loss function defining a minimal modified-MPAE.

Optionally, the modified (MPAE) is applied to include in the predicted cellular data consumption only cellular data consumption of each vehicular cellular device 202 which exceeds a predefined threshold.

The minimal modified-MPAE based loss function may be therefore defined as follows. First an indicator function may be defined for every training sample yᵢ as:

$$1 ( {y}_{i} ) = \{ \begin{matrix}1 , & {y}_{i} > τ \\ 0 , & else\end{matrix} ,$$

where τ is a preset threshold for the specific signal.

Next, given the error value eᵢ=ŷᵢ−yᵢ, for each sample in the training set, i∈{1, . . . , N}, the loss function for minimization may be defined by:

$$LOSS = \frac{{\sum }_{i = 1}^{N} 1 ( {y}_{i} ) \frac{\vert {e}_{i} \vert}{\vert {y}_{i} \vert}}{{\sum }_{i = 1}^{N} 1 ( {y}_{i} )}$$

Moreover, the parameters of the ML model, for example, the D-CNN may be optimized during training by applying a Stochastic Gradient Descent (SGD) algorithm. Applying the SGD algorithm during the learning (training) process using the batches of data samples, i.e., the time sequences of different flows (signals) may drive the ML model to adjust at each training step to reduce the MPAE between the predicted cellular traffic load values and the true (real) cellular traffic load values.

The training process may be repeated using additional training datasets until achieving a convergence to an optimal state.

The ML model trained using the historical cellular data consumption records may be thus applied by the cellular traffic predictor 220 to predict the cellular traffic load at one or more of the cellular network infrastructure apparatuses 204 at a time-horizon in the future. i.e., at one or more future times.

To predict the future value of the cellular traffic load at a certain cellular network infrastructure apparatus 204, the cellular traffic predictor 220 may feed (input) the ML model with the historical values of 2048 flow samples of the time interval preceding the current prediction time, for example, for the configuration of nominal sampling period of 15 minutes. This means an approximately 21.33 days of historical data. The input flow (signal) may be combined with the metadata channels, specifically the timing parameters (weekdays, time-of-day, etc.) exactly as it was combined in the training phase.

In addition, the flows (signals) may go through the same procedures that were described in the training phase of the ML model, specifically the preprocessing filter, scaler module, the normalization and the re-scaling.

While initially trained off-line, the ML model may be further trained after deployed to predict the cellular traffic load for the cellular network infrastructure apparatuses 204. The ML model may be also brought off-line to be further trained in an off-line manner. As such the ML model may be further trained in an on-line fusion meaning that the ML model parameters (weights) may be learnt, adjusted and/or adapted off-line or online in parallel to the operational prediction process.

Moreover, the ML model may further perform as an anomaly detector. Basically, an event in which a prediction error (absolute value) gets above a certain value may be suspected to be an anomaly of the signal. However, frequently the error may stem from the fact that the ML model does not fit the prediction process. In order to tackle this tradeoff, an anomaly analysis procedure may be executed which may affect and/or influence the logic of the ML model's parameters update.

The anomalies may be divided into two types, short-term anomalies and trend-anomalies. To perform the anomaly detection, an error tracking procedure may be executed, for example, by the cellular traffic predictor 220 over the ML model's predictions and the corresponding true values. The error tracking may be performed based on an Auto-Regression (AR) calculation: Eₙ=(1−α)Eₙ₋₁+αeₙ where eₙ is the current error (at time n), and a possible value of α is [0.8 to 0.9].

Short-term anomalies may be identified when a set of large errors (Eₙ) appear in a short period of time, for example, less than 4 hours and then disappear without continuity. The detection of a short-term anomaly is useful for retrospective investigation.

Trend anomalies may be identified when large errors (Eₙ) appear continuously and do not disappear. This type of anomaly is also important for retrospective investigation, but moreover it may indicate that a new pattern has been detected and therefore the ML model may need to be updated to better fit the new pattern data.

As stated herein before, during its operation, the ML model may be updated through a training process. While the training may be done off-line, detection of one or more trend anomalies during the operational prediction process may trigger one or more ML model fitting steps to fit the ML model to the new pattern(s) data. In such case, the sample selection procedure may prioritize the latest samples to have higher probability to be drawn for the training (learning) process compared to older samples in order to increase the probability of selecting samples exhibiting the new pattern(s).

Reference is made once again the FIG. 1.

As shown at 112, the cellular traffic predictor 220 may output, for example, transmit, deliver and/or otherwise provide the future cellular network traffic load predicted for one or more of the cellular network infrastructure apparatuses 204 to one or more of the cellular network management systems 230.

Based on the predicted future cellular network traffic load estimated for one or more of the cellular network infrastructure apparatuses 204, the cellular network management system(s) 230 may initiate one or more actions to optimize the cellular traffic management, for example, improve utilization of the cellular network, improve utilization of one or more of the cellular network infrastructure apparatuses 204, improve service of the cellular network, reduce latency of the cellular network traffic and/or the like. For example, the cellular network management system(s) 230 may apply one or more load balancing procedures to reduce the cellular traffic load expected at one or more of the cellular network infrastructure apparatuses 204 by directing cellular traffic through one or more less loaded cellular network infrastructure apparatuses 204. In another example, the cellular network management system(s) 230 may increase a transmission power of one or more remote cellular network infrastructure apparatuses 204 to enable them to serve one or more further away vehicular cellular devices 202 and relief one or more highly loaded cellular network infrastructure apparatuses 204 which are closer to these vehicular cellular device(s) 202.

According to some embodiments of the present invention, the cellular traffic load prediction may be applied to recommend a preferred route for one or more of the vehicles hosting one or more vehicular cellular devices 202 which is estimated to support best cellular network serviceability. In other words, based on the predicted cellular traffic load at one or more of the cellular network infrastructure apparatuses 204, a recommended route associated with less loaded cellular network infrastructure apparatuses 204 may be identified and transmitted to one or more of the vehicles hosting vehicular cellular devices 202. The vehicle(s) may select the recommended route in order to ensure a relatively high cellular network quality of service. This may be of particular benefit to autonomous vehicles and/or partly autonomous vehicles which may require high quality of service, for example, high bandwidth, low latency and/or the like for monitoring and/or controlling their operation.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms cellular network infrastructure apparatus, ML model and neural network are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of predicting a cellular traffic load in a certain geographical area, comprising:
identifying a plurality of in-motion vehicular cellular devices moving within a certain geographical area deployed with a plurality of network infrastructure apparatuses;
estimating future locations of the plurality of vehicular cellular devices by predicting a plurality of time series based routes of the plurality of vehicular cellular devices;
predicting a future cellular traffic load for at least one of the plurality of network infrastructure apparatuses estimated, based on the future locations, to serve at least some of the plurality of vehicular cellular devices by applying a Machine Learning (ML) Model trained, using historical cellular data consumption records, to predict the cellular data consumption of the at least some vehicular cellular devices; and
outputting the predicted future cellular traffic load to at least one management system configured to initiate at least one action in advance to optimize cellular traffic management based on the predicted future cellular traffic load.

2. The computer implemented method of claim 1, wherein the plurality time series based routes are estimated using a probabilistic model configured to compute an estimated trajectory for each of the plurality of vehicular cellular devices based on probability scores computed for estimated transitions of the respective vehicular cellular device over road infrastructure identified in the certain geographical area.

3. The computer implemented method of claim 2, wherein the positioning of at least one of the plurality of vehicular cellular devices is extracted from positioning information derived from at least one cellular activity record of cellular communication activity in the certain geographical area.

4. The computer implemented method of claim 2, wherein the positioning of at least one of the plurality of vehicular cellular devices is extracted from positioning information received from at least one positioning sensor associated with at least vehicular cellular device.

5. The computer implemented method of claim 2, wherein the probabilistic model is further configured to correlate between the route estimated for each of the plurality of vehicular cellular devices and at least one of the plurality of network infrastructure apparatuses deployed in the certain geographical area during the travel of the respective vehicular cellular device according to at least one transmission parameter computed for the respective vehicular cellular device with respect to the at least one network infrastructure apparatus.

6. The computer implemented method of claim 2, wherein the estimated trajectory is computed for each of the plurality of vehicular cellular devices based on periodically updated positioning of the respective vehicular cellular device.

7. The computer implemented method of claim 6, further comprising estimating the positioning of at least one of the plurality of vehicular cellular devices in case of unavailability of the updated positioning information for the at least one vehicular cellular device.

8. The computer implemented method of claim 1, wherein the historical cellular data consumption records used the train the ML model comprise a plurality of cellular network activity flows and events indicative of cellular data consumption of a plurality of cellular devices.

9. The computer implemented method of claim 8, wherein each of the plurality of cellular network activity flows are preprocessed before fed to the ML model by applying at least one filter to the respective cellular network activity flow.

10. The computer implemented method of claim 8, wherein each of the plurality of cellular network activity flows is normalized to map the respective cellular network activity flow in a predefined range.

11. The computer implemented method of claim 1, wherein each of the plurality of predicted routes fed to the ML model is further coupled with metadata comprising at least one timing parameter which is a member of a group consisting of: a current time of day and a current day of the week.

12. The computer implemented method of claim 1, wherein the historical data is extracted from at least one cellular communication activity record of cellular communication activity in the certain geographical area.

13. The computer implemented method of claim 1, wherein the ML model is utilized by at least one Dilated Convolutional Neural Network (D-CNN).

14. The computer implemented method of claim 13, wherein the D-CNN is constructed of an input layer, twelve convolutional layers, two dense layers and an output layer.

15. The computer implemented method of claim 14, wherein a dilation rate of multiplied by a factor of two for each of the twelve convolutional layers compared to its preceding convolutional layer.

16. The computer implemented method of claim 14, wherein the D-CNN further comprising at least one dropout layer between a first dense layer of the two dense layers and a second dense layer of the two dense layers.

17. The computer implemented method of claim 1, wherein the ML model is trained using a loss function defining a minimal modified Mean Percentage Absolute Error (MPAE), the modified (MPAE) is applied to include in the predicted cellular data consumption only cellular data consumption of each of the at least some vehicular cellular devices which exceeds a predefined threshold.

18. The computer implemented method of claim 1, wherein the ML model is optimized during training by applying a Stochastic Gradient Descent (SGD) algorithm.

19. A system for predicting a cellular communication traffic load in a certain geographical area, comprising:
at least one processor executing a code, the code comprising:
code instructions to identify a plurality of in-motion vehicular cellular devices moving within a certain geographical area deployed with a plurality of network infrastructure apparatuses;
code instructions to estimate future locations of the plurality of vehicular cellular devices by predicting a plurality of time series based routes of the plurality of vehicular cellular devices;
code instructions to predict a future cellular traffic load for at least one of the plurality of network infrastructure apparatuses estimated, based on the future locations, to serve at least some of the plurality of vehicular cellular devices by applying Machine Learning (ML) Model trained, using historical cellular data consumption records, to predict a cellular data consumption of the at least some vehicular cellular devices; and
code instructions to output the predicted future cellular traffic load to at least one management system configured to initiate at least one action in advance to optimize cellular traffic management based on the predicted future cellular traffic load.

20. A computer readable medium comprising program instructions executable by at least one processor, which, when executed by the at least one processor, cause the at least one processor to perform a method according to claim 1.
